(19) United States
(12) Patent Application Publication
(10) Pub. No.: US 2014/0224894 A1
(43) Pub. Date: Aug. 14, 2014

(54) TECHNIQUE TO MITIGATE STORMS USING ARRAYS OF WIND TURBINES

(71) Applicant: The United States Government, as represented by the Secretary of Commerce, (US)

(72) Inventor: Alexander E. MacDonald, Boulder, CO (US)

(73) Assignee: The United States Government, as represented by the Secrelary of Commerce, Silver Spring, MD (US)

(21) Appl. No.: 13/762,652

(22) Filed: Feb. 8, 2013

(51) Int. Cl. A01G 15/00

(52) U.S. Cl. CPC A01G 15/00
USPC 239/2.1; 239/14.1

(57) ABSTRACT

This invention describes a system whose operation can change the track and intensity of atmospheric storms. The invention uses arrays of wind turbines which are being built for power generation. Using existing atmospheric and storm tracking models, calculations of a storm track may be determined to establish a baseline track calculation. The storm track may then be calculated for a number of permutations where various groups or individual wind turbines are curtailed (e.g., feathered). The optimal storm track may be determined based on damage estimate calculations. Signals may be sent to individual or groups of wind turbines to curtail the turbines to alter the track of the tropical storm.

### STATEMENT OF GOVERNMENT INTEREST

The research that led to the development of the present invention was sponsored by the National Oceanic and Atmospheric Administration's (NOAA's) Earth System Research Laboratory. NOAA is a part of the U.S. Department of Commerce, a component of the U.S. Federal government. The United States Government has certain rights in the present invention.

### FIELD OF THE INVENTION

The present invention relates to a system whose operation can change the track and intensity of atmospheric storms. In particular, the present invention is directed toward the use of arrays of wind turbines, which are being built for power generation, to alter the path of tropical storms, and other weather phenomena such as severe storms and droughts.

### BACKGROUND OF THE INVENTION

The present invention includes a system whose operation can change the track and intensity of atmospheric storms and other weather phenomena. The invention uses arrays of wind turbines, which are built for power generation. In an example illustrated herein, a hypothetical modification of the track of Hurricane Irene is discussed. This storm struck the eastern coast of the US in August 2011 causing more than $5 billion in damages, and 45 fatalities. An estimate, described below, is that the technique described in the present invention could have moved the path of Hurricane Irene progressively further east as it moved up the eastern seaboard, keeping the most dangerous winds and precipitation off the coast.

The concept of large-scale modification of storms was introduced by Hoffman (Hoffman, Ross N., 2002: Controlling The Global Weather. Bull. Amer. Meteor. Soc., 83, 241-248, incorporated herein by reference). In a later paper (Hoffman, R. N., J. M. Henderson, S. M. Leidner, C. Gras sotti, and T. Nehrkorn, 2006: The response of damaging winds of a simulated tropical cyclone to finite amplitude perturbations of different variables. J. Atmos. Sci., 63 (7), 1924 1937, also incorporated herein by reference), the sensitivity of tropical cyclones to perturbations of wind and temperature was discussed. The latter paper did not describe a technique to develop such perturbations, but rather stated: “Clearly it will be a long time before it is possible to control a tropical cyclone in reality . . . ” The assumption is that the energy required to change storm path and intensity was described as well beyond existing human technology.

A number of references exist in the Prior Art, which are directed toward predicting or controlling weather. Some of these references discuss the effects that wind turbines have on the environment, particularly as they mix different layers of air. However, none of these references suggest intentionally controlling this effect to alter the weather or alter the course of hurricanes.

Aberson, S. 2001: The ensemble of tropical cyclone track forecasting models in the North Atlantic basin (1976-2000). Bull. Amer. Meteor. Soc., 82, 1895-1904, incorporated herein by reference, discloses forecasting models for tropical cyclones. This reference discloses forecast models, but does not disclose how to alter hurricane tracks.

Barrie, D., D. B. Kirk-Davidof, 2010: Weather response to a large wind turbine array. Atmos. Chem. Phys., 10, 769-775, incorporated herein by reference, discloses how large wind turbine arrays can affect local weather. This reference is relevant in that it discloses how a hypothetical network over the central US would change atmospheric energy at a level above initial atmospheric uncertainty, resulting in predictable downstream changes to the large scale tropospheric flow. Barrie and Kirk-Davidoff do not teach or suggest an algorithm for controlling such an array, nor do they suggest intentional control of such a phenomenon.

Lorenz, E. N., 1963: Deterministic nonperiodic flow. J. Atmos. Sci., 20, 130-141, incorporated herein by reference, discusses how very minor perturbations in current atmospheric states can result in large differences at later times.

Lewis, J., S. Lakshmivarahan, and S. Dhall, 2006: Dynamic Data Assimilation: A Least Squares Approach. Cambridge Univ. Press, 745 pp, incorporated herein by reference, is a textbook on the assessment, combination and synthesis of observational data, scientific laws and mathematical models to determine the state of a complex physical system, for instance as a preliminary step in making predictions about the system's behavior.

Published PCT Application WO 2011/134281 A1, published Apr. 28, 2011, based on Chinese Patent Application 2010/10160384.5 filed Apr. 30, 2010, both of which are incorporated herein by reference, discloses using fans to blow atmospheric gases from one region to another.

Control of weather by using cloud-seeding and similar techniques are known in the art, with varying degrees of success. Published Japanese Patent Application JP2005/013017, published Jan. 20, 2005 and incorporated herein by reference, discloses a technique for seeding clouds using balloons. Brandau et al., U.S. Pat. No. 2,756,097, issued Jul. 24, 1956 and incorporated herein by reference, discloses what appears to be a variation on cloud seeding by introducing liquids into an aircraft exhaust. Kasemir et al., U.S. Pat. No. 3,284,005, issued Nov. 8, 1966 and incorporated herein by reference, discloses a variation on cloud seeding by altering the electrical charge within a cloud. Cordani, U.S. Pat. No. 6,315,213, issued Nov. 13, 2001 and incorporated herein by reference, discloses a technique for cloud seeding using an cross-linked aqueous polymer. Papee et. al. Reissued U.S. Pat. No. RE 29,142, issued Feb. 22, 1977 and incorporated herein by reference, discloses combustible compositions for generating aerosols for cloud modification. Tew at al., Published PCT Application WO 2007/105014, published Sep. 20, 2007 and incorporated herein by reference, discloses a technique for neutralizing strong winds through use of cloud seeding.

There are also a number of references which discuss mitigating the intensity of hurricanes, cyclones, or tornados. Many of these rely on altering the temperature gradient of ocean water. Van Huisen, U.S. Pat. No. 3,741,480, issued Jun. 26, 1973 and incorporated herein by reference, discloses a smog and weather control system using geothermal wells to heat the top surface of a body of water. Konstantinovskiy, U.S. Pat. No. 7,810,420, issued Oct. 12, 2010 and incorporated herein by reference, discloses a method of interrupting a tornado by injecting liquid nitrogen into the tornado. Gradle, U.S. Pat. No. 8,148,840, issued Apr. 3, 2012 and incorporated herein by reference, discloses an ocean wind water pump for de-energizing a storm. A wind-powered water pump brings cold water to the surface. Sirovich, U.S. Pat. No. 8,262,314 and incorporated herein by reference, issued Sep. 11, 2012, discloses a method for decreasing the intensity and frequency of tropical storms. Water layers are mixed to reduce the temperature gradient in the water. Vondracek, Published U.S. Patent Application No. 2007/025126, published Nov. 8, 2007 and incorporated herein by reference, discloses a technique to mitigate tropical cyclone damage. Again, pumping is used to mix colder water from lower depths to reduce surface sea temperatures. Salva et al., Published U.S. Patent Application No. 2010/0072297, published Mar. 25, 2010 and incorporated herein by reference, discloses a method for controlling hurricanes. Scores of jet planes with afterburners are flown into the hurricane to create small changes in temperature.

There have been published, a number of popular articles on the subject of weather control and how wind farms may alter weather conditions. Wind Farms Affect Local Weather, BBC News, Science & Environment, published Apr. 29, 2012 and incorporated herein by reference, discloses how a study published in the journal Nature Climate Change showed that turbines located in West Texas had an impact in local weather. This is merely a cumulative reference, as the Barrie reference cited by the inventor also discloses this fact. Wind Farms Can Cause Climate Change, Finds New Study, Daily Telegraph, published Apr. 29, 2012 and incorporated herein by reference, appears to report on the same study as the BBC article. Large Wind Farms Increase Temperatures Near Ground, Wall Street Journal, published Apr. 30, 2012 and incorporated herein by reference, reports on the same study as the previous two references.

China Leads Weather Control Race, Wired.com, published Nov. 14, 2007 and incorporated herein by reference, discusses advances in weather control in China, which seem to be limited to cloud seeding and the like. Cloud seeding is well-known in the art, but does not alter the course of wind storms, but rather merely induces precipitation, when it has been known to work.

None of these these references teach or suggest how to alter the track of a storm using an installed base of wind turbines, or how to change other weather phenomena by systematic curtailment of such turbine arrays.

### SUMMARY OF THE INVENTION

The present invention utilizes the emerging worldwide trend in wind power generation, together with the invention of a new technique, to prescribe how storms may be influenced in some (but not all) cases. The driving energy source that is required for storm modification is an extensive geographic network of wind turbines similar to those now being contemplated in the US and other countries. The size and configuration of these wind power networks are based on the requirement for national energy systems; in general, the storm control technique may require large spatial and energy characteristics.

The system utilizes many turbines over an extended geographic domain, which may be curtailed individually, spatially and temporally according to patterns derived from an algorithm developed by the inventor. With regard to use of the term “curtailment” of wind turbines, in the present invention, it is assumed that the wind turbine can be used in the general case to change momentum within the envelope of the characteristics of the turbines. The algorithm, named Storm Track and Intensity Controller Technique (STRICT), uses large numbers of atmospheric model runs, which specify a pattern of curtailment of energy production for the wind turbines. The STRICT algorithm delivers a new probabilistic track and intensity, which may be chosen and implemented to decrease negative effects of storms, or to enhance positive effects (e.g. bring rain to drought-stricken areas). Implementation consists of changing the characteristics of each turbine in a network according to the STRICT specification for a 12 hour period. Typically, each subsequent 12 hour period can be recalculated and executed according to the STRICT algorithm. Experimentation may show that other periodic modifications (e.g. every 6 hours or 24 hours) may have some advantages.

It is widely understood that atmospheric storms such as tropical storms, low pressure systems that bring rain, snow and wind over wide areas, and thunderstorms which may spawn tornados, hail and flashfloods are immensely energetic compared to human controlled energy systems. However, an inherent characteristic of weather, called the butterfly effect, was identified by Lorenz, E. N., 1963: Deterministic nonperiodic flow. J. Atmos. Sci., 20, 130-141, incorporated herein by reference. Lorenz showed that very minor perturbations in current atmospheric states may result in large differences at later times. Lorenz used the example that a few butterflies flapping their wings at an earlier time could be responsible for a tornado months later in a different location. In the technique described here, the change in momentum caused by curtailment of hundreds of thousands of wind turbines over a large geographic domain would change the structure of atmospheric waves, with the size and configuration of the changes growing with time according to the non-linear dynamics elucidated by Lorenz.

A more recent study by Barrie and Kirk-Davidoff (Barrie, D., D. B. Kirk-Davidof, 2010: Weather response to a large wind turbine array. Atmos. Chem. Phys., 10, 769-775, incorporated herein by reference) showed that a hypothetical network over central US would change atmospheric energy at a level above initial atmospheric uncertainty, resulting in predictable downstream changes to the large-scale tropospheric flow. Since the track and intensity of storms is controlled by large scale tropospheric flow, it is feasible to control storms using the algorithm described in the present invention.

The prospect of directing hurricanes away from the US coast and other storm control is predicated on the development of large-scale wind turbine networks. An example of the optimal network for the 48 contiguous US States is illustrated in FIG. 1, which illustrates the location of proposed wind generation stations in the US. This is one possible configuration for a national network of wind turbines, however the invention is feasible for almost any large national array because of the large energy changes that such a turbine array can selectively generate. In this particular configuration there are a large number of wind turbines over the central United States. In this system configuration there are 240,000 3 Mw wind turbines providing an average of 52% of US electric energy over a year. Typically such a network is withdrawing several hundred Gigawatts of energy from the atmospheric boundary layer. The systematic curtailment (i.e. turning off or “feathering” the blades so that they do not withdraw energy from the air) of the wind turbine network can cause changes in the momentum structure above the turbines. An atmospheric prediction model provides an estimate of how such changes would be propagated downstream (or more correctly, in all directions). The STRICT algorithm of the present invention produces a schedule of curtailment which, if followed, makes a probabilistic change in storms affected by the downstream changes propagated by the flow.

As described above, all forces in the atmosphere, from the flapping of butterfly wings to the momentum changes resultant from shutting off hundreds of thousands of wind turbines, cause changes in future weather. The invention described here takes advantage of two new factors. First, the skill of global and regional weather models has consistently increased over recent decades; the average track error at landfall of a tropical storm has decreased from 400 miles 40 years ago to less than 100 miles today. The second is that the combined effect of hundreds of thousands of multi-megawatt wind turbines represents a larger discretionary energy input than humans have controlled previously.

A point of interest is that if large-scale wind turbine networks are implemented, the STRICT algorithm will change the track storms in a general sense toward what they would have been if the networks did not exist. This concept can be stated in another way to help understanding. A large network of wind turbines will have a significant effect on the downstream weather because of the chaotic nature of the atmosphere. Most of the time these effects will be relatively small, but sometimes, due to atmospheric instability, they will grow exponentially with time. The core of the algorithm invented by the author is to identify when downstream amplification of the perturbation due to the wind turbine curtailment will move the target storm in a desirable direction.

### BRIEF DESCRIPTION OF THE DRAWINGS

FIG. 1 is a diagram illustrating an optimized wind and solar network capable of supplying about 70% of US power.

FIG. 2 is a diagram illustrating three colored boxes as areas perturbed in the Large Area Perturbation Technique.

FIG. 3 is a diagram illustrating the estimated modification of Hurricane Irene track with 300 Gigawatts of curtailment in the western plains.

FIG. 4 is a block diagram illustrating the main components of the present invention.

FIG. 5 is a flowchart illustrating the steps used in the method of the present invention.

### DETAILED DESCRIPTION OF THE INVENTION

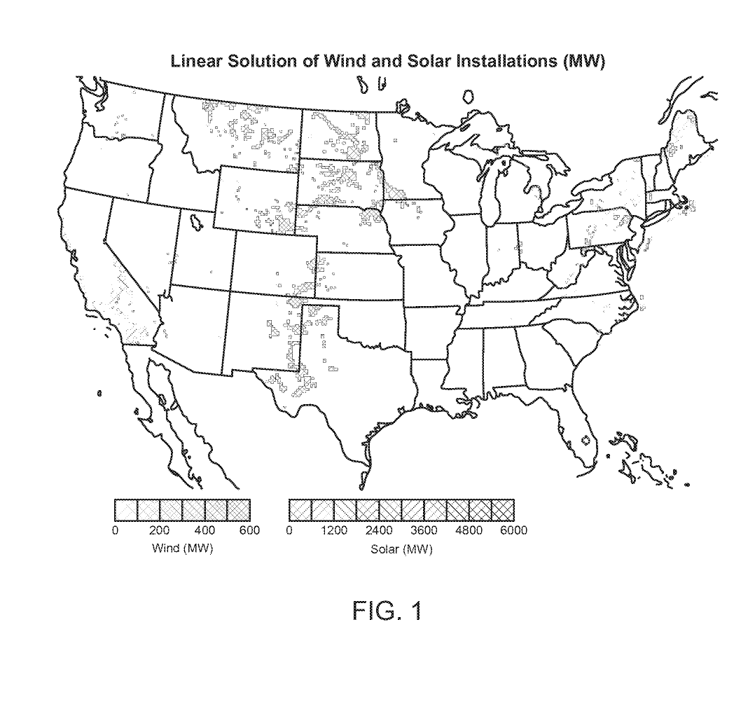

FIG. 1 is a diagram illustrating an optimized wind and solar network capable of supplying about 70% of US power. The dark areas in the plains represent blocks of about 170 square kilometers, with the total wind turbine power color coded. A typical block colored deep blue would have about 150 3 Megawatt wind turbines. Curtailment of a block of wind turbines would add about 450 megawatts of wind energy to the column above the turbines. Total power generation capability of the plains network shown is about 600 Gigawatts.

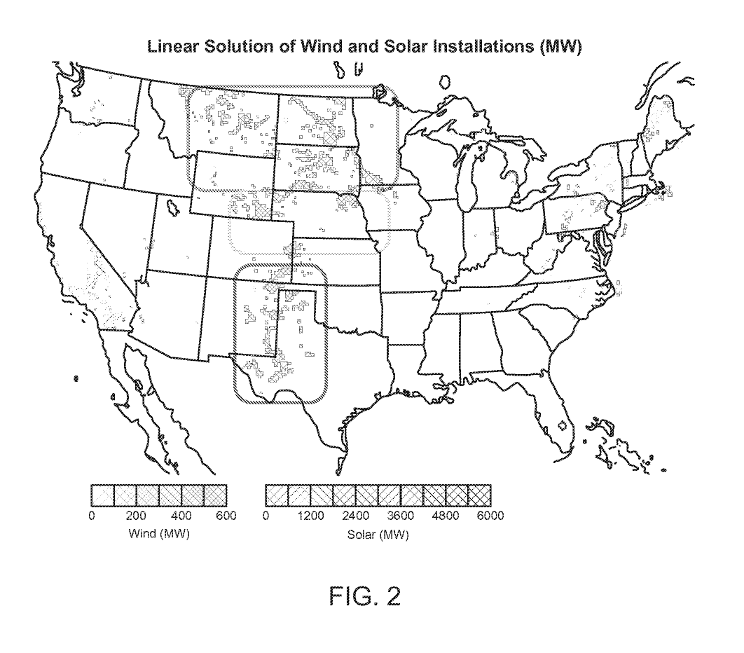

FIG. 2 is a diagram illustrating three shaded boxes as areas perturbed in the Large Area Perturbation Technique. Each area can be completely curtailed, or not, giving rise to eight different possible modes of curtailment. These are then used with predictive models to determine the downstream effect of the perturbations. The curtailment is chosen for maximum desirable effect on the storm.

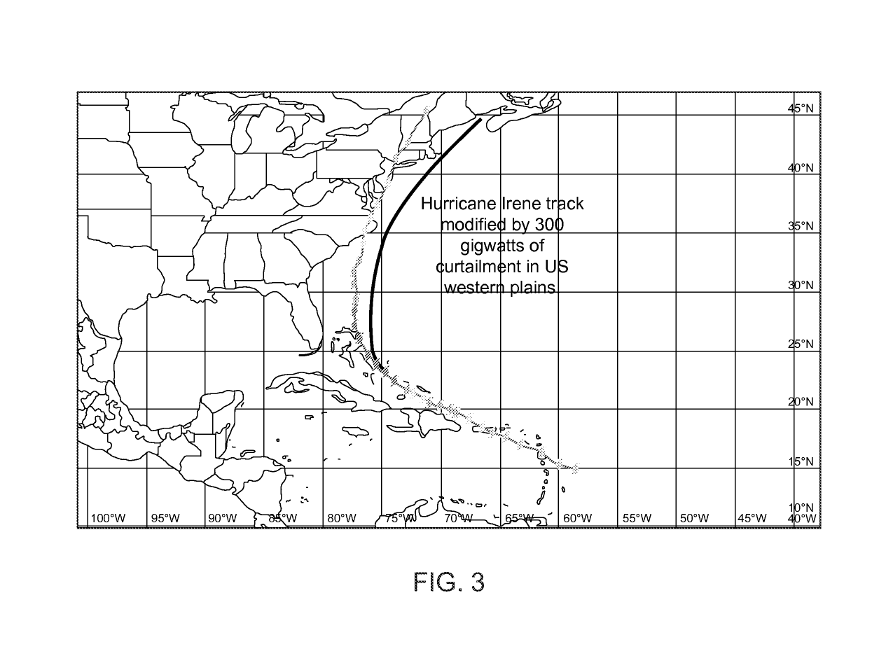

FIG. 3 is a diagram illustrating the estimated modification of Hurricane Irene track with 300 Gigawatts of curtailment in the western plains. The wind and pressure perturbation in this simple case is assumed amplify with a doubling period of 36 hours, moving downstream from the wind turbine array to push the storm further east away from the US coast.

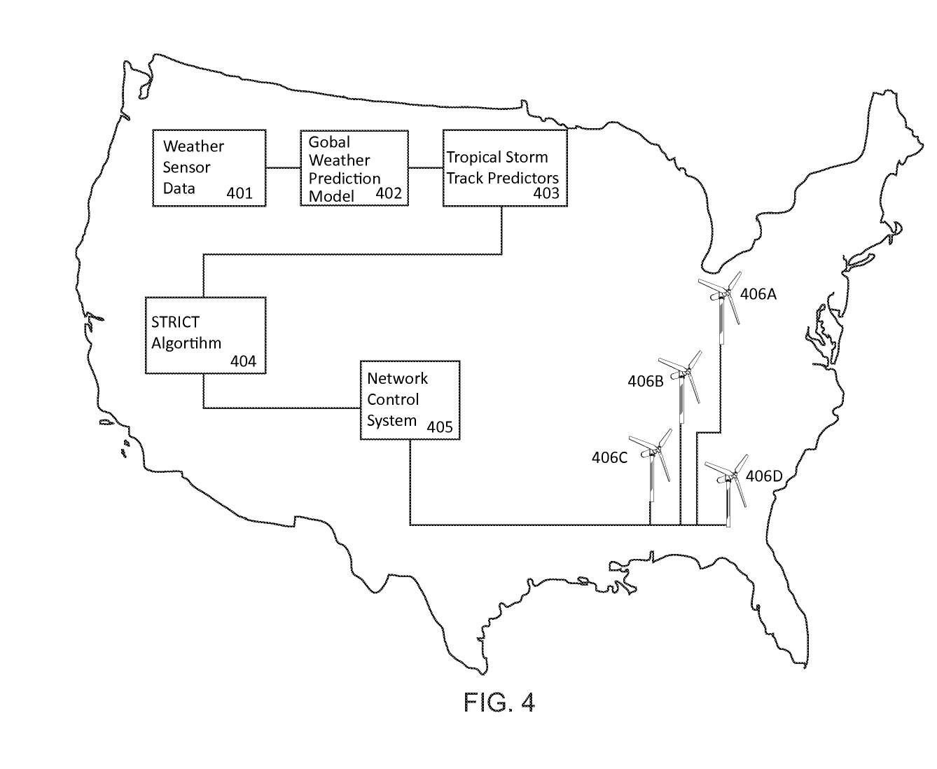

FIG. 4 is a block diagram illustrating the main components of the present invention. The following illustration of the STRICT algorithm is described in connection with a specific case to enhance understanding of how it works. In this case, a network of wind turbines 406A-DC is used, designed for an optimal wind and solar energy system in the US 48 states is illustrated in FIG. 1. For the purposes of illustration, four wind turbines 406A-D are shown schematically. These represent a network or networks of wind turbines, as described in connection with FIG. 1. The efficacy of the present invention is proportional to the number of installed wind turbines.

The example of Hurricane Irene is applied to illustrate the present invention. Hurricane Irene existed from August 20 to its decay in early September, impacting the US east coast between August 25 and August 29. An important aspect of the STRICT Algorithm is that the storm was predicted by global models as much as three days before it formed.

Modern weather prediction models 402 are capable of making predictions 403 of future atmospheric states which, over a period of days, gradually depart more and more from the observed states. A global weather prediction model 402 may receive inputs from various weather sensor data 401 including but not limited to satellite imagery data, temperature and wind data, atmospheric pressure data, ocean temperature data, and the like. The use of model 402 ensembles allow multiple predictions 403 with perturbed initial states to represent an envelope of possible states. As an example, a hurricane located in the Caribbean could take a number of different tracks. Multiple model runs can show many tracks which generally “cluster” around the most likely track if the model has skill in both its predictions and perturbation growth. The STRICT 404 algorithm uses an ensemble of model predictions 403 as an important part of its technical basis.

The STRICT algorithm 404 uses the global weather prediction model 402 to establish a baseline for weather prediction. For example, global weather prediction model 402 may produce storm track prediction 403 based on normal model parameters. The STRICT algorithm may then compare this baseline model to altered models, where various wind turbines 406A-D are disabled or deactivated (curtailed), and the resulting affect on the storm track re-calculated and compared to the original baseline model. Network control system 405 may send signals to electronic controllers to automatically shut down (feather) or otherwise disable or curtail turbines or groups of turbines. Alternately, or in addition, network control system 405 may send signals via the Internet to various utility and wind turbine operators, instructing them to curtail a number of turbines as calculated by the STRICT algorithm.

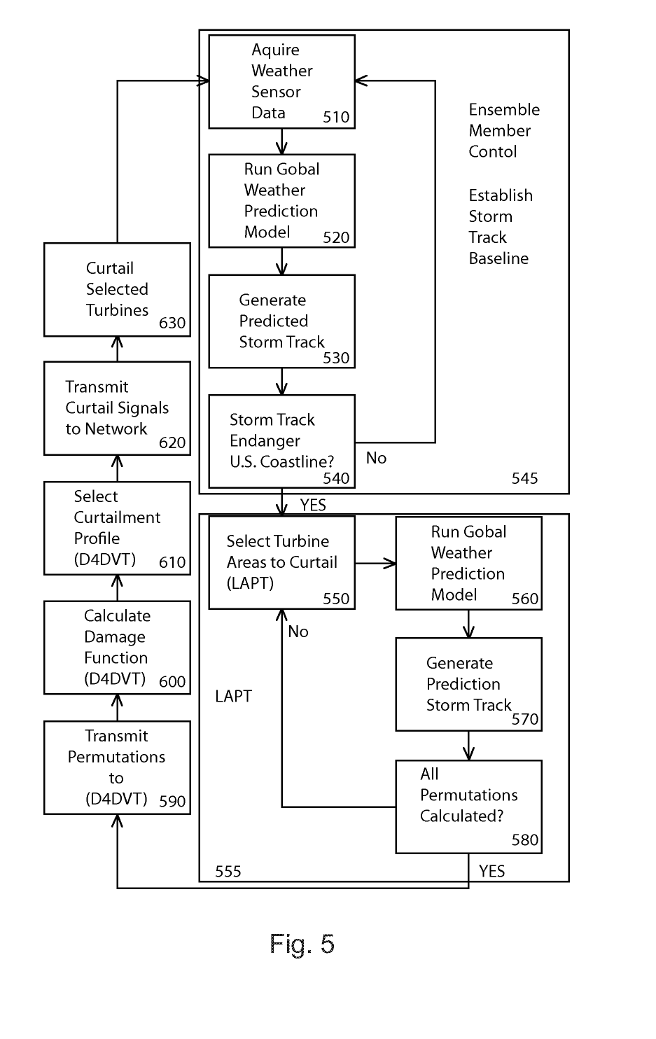

FIG. 5 is a flowchart illustrating the steps used in the method of the present invention. As illustrated in FIG. 5, in step 510, weather sensor data is acquired, as discussed previously in connection with FIG. 4. In step 520, a global weather prediction model is run to generate a predicted storm track 530. Again, the global weather models and storm track generating techniques are known in the art, and thus need not be described here in detail. In step 540 a determination is made whether the projected storm track would endanger the US coastline or other area of interest. If the storm is projected to remain offshore, no further action may be taken, and processing returns to step 510.

The system uses many model integrations to arrive at a best estimate of the spatial and temporal sequence of wind turbine curtailment. The curtailments are given in 12 hour windows, based on model integrations that are run every 12 hours. Thus, a premium is on the rapidity of calculation to determine the sequence as soon after model initialization time as possible. As an example, start with an initial time of 00 UT. If all the assimilation and model runs could be completed in six hours, the curtailment window would be from 6 to 18 hours after the initial time.

Using advanced assimilation, it is assumed that an initialization system has arrived at an optimal estimate of an ensemble of initial states. To distinguish the ensemble of initial states from the ensemble of multiple predictions from each of the initial states, we refer to the former as the “Ensemble of Initial States” (EIS). The prediction models 530 are integrated forward for an extended period, typically 7 to 10 days.

Two complementary techniques are used in the calculation. The first is the Large Area Perturbation Technique, which will be described here. The second is the Detailed 4 D Variational Technique (D4DVT), which is described below. The techniques are complimentary because the LAPT can be used to determine the larger scale characteristics of the storm modification method, while the detailed, turbine by turbine specification can come from the D4DVT. LAPT starts with a small number of geographic areas. For illustration, we use three areas, as shown in FIG. 2. The arrangement of the areas would in general be based on experience and testing, but in this case we have chosen a north south division. The three areas are treated as blocks in this simple case; it is prescribed that each of the areas will uniformly execute the same temporal sequence of curtailments. Of course, any number of areal subdivisions could be used, based on experience, testing and computational resources available.

The LAPT 555 uses multiple model integrations for each of an Ensemble of Initial States. The first model integration for each member is the “ensemble member control” 545. This is a run that does not have any wind turbine curtailment, as illustrated in steps 510-530 in FIG. 5. These steps establish the baseline storm track without curtailment. Then, an additional set of model runs are conducted for each EIS in steps 550-580. In step 550, a turbine area is selected for curtailment. In step 560, the global weather prediction model is run and a predicted storm track is generated in step 570. In step 580, the new storm track is compared to the baseline storm track from block 545. Once the storm track has been improved or optimized, the process is complete. If not, the process repeats for every combination of turbine curtailment, as illustrated in LAPT block 555.

The number of prediction runs for each initial state (each EIS) could be chosen as all perturbations of the initial areas, with two allowable states—fully curtailed or un-curtailed. Other more complex perturbation methods may also be used, such as partial curtailment of turbines, or the like. In the simple case, three different areas with binary states result in eight possible states, or seven, plus the control run. The eight prediction runs are accomplished for each of the EIS, so the total number of prediction runs is EIS*NR. Thus if there are 20 initial states (EIS=20), then there would have to be 20*8=160 model prediction runs.

The second stage of the LAPT is to select a strategy of curtailment based on the multiple ensemble runs. For example, a simple strategy (which may not be optimal after testing) is to take the ensemble of each perturbation to determine which perturbation moves the prediction most favorably in the desired direction for track and intensity change, as illustrated in block 580. The model prediction runs should also include a number of future scenarios of turbine curtailment to enhance the choice of the best current curtailment. There may be some human judgment involved with this step because of the trade-off between track and intensity. The various permutations (raw or edited by humans) may then be input to the D4DVT as illustrated in step 590.

The Detailed 4 Dimensional Variational Technique (D4DVT) uses the methodology of four dimensional variational assimilation to determine the detailed schedule of curtailment for each wind turbine. The discipline of four dimensional assimilation (henceforth referred to as 4DVAR) has a 30 year history in atmospheric applications and is used by many global weather prediction centers. In this case the 4DVAR technique is adapted to search for optimal wind turbine curtailment rather than optimal atmospheric analysis. By using the perturbation technique described above, the speed and likelihood of convergence of this algorithm are increased.

The D4DVT seeks to minimize future damage from a tropical storm. Thus it depends on definition of a “damage function”, that must relate the total damage from the storm from the first time that can be affected (e.g. 6 hours from the initial time) to the end of the model integration. The damage functions 600 can be a varying complexity, including wind damage functions and flooding functions based on precipitation. A very simple example could be to use population density and the cube of the surface wind as proportional to the destructive power. The total damage could be approximated by the population of each county affected times the maximum of the wind damage function. A computational detail is that the area around the tropical storm must be masked such that only the winds from the tropical storm enter into the minimization; this is similar to the spatial masks used in conventional 4DVAR, except that it should not be tapered with distance. Software that tracks the center of tropical storms in prediction models would typically be used as the center for an influence radius of a couple hundred kilometers.

From the damage functions 600, the system may then select the best curtailment profile in step 610 from the permutations calculated in the LAPT block 555. The corresponding curtailment signals may then be sent in block 620 to curtail individual or groups of turbines in step 630. Curtailment may be achieved by shutting down (feathering) individual or groups of turbines using commands sent through a network to control systems operating the turbines. Alternately, these signals may be send as communications (e.g., e-mail, or the like) to utility companies and turbine operators, who in turn may enter commands into their systems to feather individual or groups of turbines.

The control variable is the curtailment function of the wind turbines. The curtailment function varies from 0 to 1, where 0 indicates the wind turbine is completely feathered, and 1 means it is operating at full power allowed. Simplifications that can be used, such as blocking the wind turbines e.g., by having all of the wind turbines in a model grid element act in unison. Further, although the wind turbine curtailment function can enter the functional through a complex algorithm, it can be simplified by converting the curtailment into a momentum modification of the wind in the layers that encompass the turbine blades. In any case, the conversion of the momentum modification into its effect on the prediction model is crucial to the accuracy of the technique.

Following conventional 4DVAR approaches (Lewis et al, 2006) a function is defined with the damage variables to be minimized, and a prediction model as a strong constraint. The model is integrated forward, and then backward to obtain the gradient of the function with respect to the control variables—the curtailment of each of the turbines. The gradient of the cost function is then used with a search algorithm, such as the steepest descent or conjugate gradient, to determine the minimum damage configuration. This is used to specify the curtailment of the wind turbines during the 6 to 18 hour period after the initial time. The period of model prediction can be chosen to end arbitrarily. Typically, for efficiency, it would end when the damage potential of the storm goes below a threshold. In the Hurricane Irene case it could be after the storm has dissipated far out in the North Atlantic.

The STRICT algorithm described above will not work in every case. It works best if the storm to be modified is downstream, and if the meteorological conditions strong amplify the initial perturbation. In a simple example, using data from Hurricane Irene, assume that the wind turbine network perturbation is 300 Gigawatts. Thus, the boundary layer gains 300 Gigawatts for a 12 hour period, which is 1.3*1016 joules of energy. This perturbation propagates down-stream and upward into the mid-troposphere at approximately the speed of the mid tropospheric wind flow, e.g. 20 m/s. At this speed, it takes 72 hours to reach the area of the hurricane. Assume an amplification doubling time of 36 hours (many perturbations amplify much more rapidly); by the time the perturbation reaches the western Atlantic, its total energy is 5*1016 joules. Scaling the perturbation by a reasonable mid-latitude resonant Rossby radius for August gives a radius of about 800 km, corresponding to the horizontal extent of the perturbation; at the speed of 20 m/s, the distance covered in 12 hours is 864 km. It is assumed that the energy of the system is strongest in the mid troposphere, and is partitioned between kinetic and potential energy. Two highly damaging Hurricanes in the last couple of decades that had very sensitive periods in their approach to the US mainland were Hurricane Andrew in 1992, and Hurricane Sandy in 2012. Both of these storms would be excellent candidates for the STRICT—testing will be conducted to determine how the technique would work in these and other cases.

Distributing energy in the vertical according to height in the atmosphere gives a mid-level momentum change of about 1 m/s at the “steering level” (Abserson, 2001) of about 700 mb, similar to the perturbations found over the western Atlantic described by Barrie and Kirk-Davidoff (2010). As illustrated in FIG. 3, the track of Hurricane Irene can be modified by assuming that it is pushed further eastward at approximately 1 m/s as it traverses the mid-latitude region downstream from the wind network shown in FIG. 1. The storm crossed 25 N at 15 GMT on August 25 and reached 50 N at 15 GMT on August 29. The total displacement for the period of 4 days at 1 m/s would be about 345 km (216 miles). This example is illustrated by the contrasting tracks of FIG. 3. The light shaded track shows the actual storm center, which affected the US from the Carolinas to Maine. The dark track shows where the storm would have gone based on the discussion above. It can be seen that by moving the storm over 200 miles to the east, the damage to the US east coast would have been significantly mitigated.

Several aspects of this calculation should be mentioned. The “moving” of the storm discussed depends on relatively high differential energy production from the wind turbine array, and a fairly strong amplification. In reality, each 12 hours would be an opportunity that the STRICT algorithm would reveal. During some periods, the winds would be weaker, so the initial perturbation might only be 150 Gigawatts. Similarly, barotropic (getting energy from the pre-existing jet stream) and baroclinic (getting energy from temperature contrasts) instability can result in positive or negative amplification. The STRICT algorithm shows the envelope of likely results of a given wind turbine curtailment strategy, allowing policymakers to determine if the effect on storms is desired. Since there is an opportunity every 12 hours, which would be 10 opportunities for a storm that lasts 5 days (about the mean lifetime), there are many chances for the system to provide helpful modifications.

Another important aspect of the STRICT technique would be the use of linear programming to estimate the least damaging paths. This technique uses the geographic distribution of the built environment and population locations to determine the best path to steer a storm when there is diversity in the potential motion. It complements the technique with a way to minimize damage.

In a country with large wind turbine arrays, the invention described herein may occasionally give policymakers the opportunity to influence weather. There is no question based on the physical formulation described in this disclosure that the system will work.

Note that while described herein in terms of altering storm tracks, in particular tropical storms and hurricanes, the present invention may be used to alter weather in general. For example, global weather prediction models may be used in conjunction with the STRICT algorithm to determine the influence of turbines on drought, rainfall, cloud cover, high winds, and other weather patterns. Turbines may be selectively curtailed in order to enhance weather conditions based on the iterative calculations of the STRICT algorithm.

While the preferred embodiment and various alternative embodiments of the invention have been disclosed and described in detail herein, it may be apparent to those skilled in the art that various changes in form and detail may be made therein without departing from the spirit and scope thereof.

I claim:

1. A system for altering track of a storm, comprising:
a plurality of weather data sensors acquiring weather data in real-time,
a climate modeling computer, coupled to the plurality of weather data sensors, receiving the weather data in real-time and modeling weather patterns, including storm patterns,
a storm track prediction computer, coupled to the climate modeling computer, receiving the storm patterns from the climate modeling computer and calculating potential storm tracks, and iteratively adding a plurality of turbine curtailment scenario combinations to the climate modeling computer, the turbine curtailment scenario combinations describing curtailing operations of different numbers of power-generating wind turbines, the storm track prediction computer receiving from the climate modeling computer a plurality of predicted storm patterns based on the plurality of combinations of wind turbine curtailment scenarios and selecting a wind turbine curtailment scenario which produces a most favorable storm track, and
an output network, coupled to the storm track prediction computer, receiving the curtailment scenario producing the most favorable storm track, and communicating that curtailment scenario to a network of wind turbines, to curtail the wind turbines in such a manner as to optimally alter the storm track.

2. The system of claim 1, wherein the storm track computer calculates storm damage based on the plurality of predicted storm patterns, and selects the curtailment scenario producing the least amount of storm damage.

3. The system of claim 1, wherein the storm track computer recalculates potential storm tracks over time, and adjusts wind turbine curtailment scenarios in response to recalculated potential storm tracks.

4. The system of claim 1, wherein the wind turbine curtailment scenarios comprise of one or more of feathering of individual or groups of power-generating wind turbines.

5. The system of claim 1, wherein the output network comprises a data network coupling the storm track prediction computer to a plurality of power-generating wind turbine operators.

6. A system for predicting a track of a storm in response to curtailment of power-generating wind turbines, comprising:
a storm track predictor, coupled to a climate modeling system receiving weather data in real-time and modeling weather patterns, including storm patterns, the storm track predictor iteratively calculating potential storm tracks using a number of combinations of wind turbine curtailment scenarios for curtailing operations of different numbers of power-generating wind turbines, the storm track prediction computer selecting a wind turbine curtailment scenario which produces a most favorable storm track, and
an output network, coupled to the storm track prediction computer, receiving the curtailment scenario producing the most favorable storm track, and communicating that curtailment scenario to a network of wind turbines, to curtail the wind turbines in such a manner as to optimally alter the storm track.

7. The system of claim 6, wherein the storm track computer calculates storm damage based on the plurality of predicted storm patterns, and selects the curtailment scenario producing the least amount of storm damage.

8. The system of claim 7, wherein storm damage is calculated based on predicted localized damage estimate calculations, including one or more of wind, flood, coastal inundation, storm tides, and location of populated areas relative to storm track.

9. The system of claim 6, wherein the storm track computer recalculates potential storm tracks over time, and adjusts wind turbine curtailment scenarios in response to recalculated potential storm tracks.

10. The system of claim 6, wherein the wind turbine curtailment scenarios comprise of one or more of feathering of individual or groups of power-generating wind turbines.

11. The system of claim 6, wherein the output network comprises a data network coupling the storm track prediction computer to a plurality of power-generating wind turbine operators.

12. A method for altering track of a storm, comprising the steps of:
acquiring, with a plurality of weather data sensors, weather data in real-time,
modeling weather patterns, including storm patterns, in a climate modeling computer coupled to the plurality of weather data sensors and receiving the weather data in real-time,
receiving, in a storm track prediction computer coupled to the climate modeling computer, the storm patterns from the climate modeling computer and calculating potential storm tracks,
iteratively adding a plurality turbine curtailment scenarios to the climate modeling computer, the plurality of turbine curtailment scenarios describing curtailing operations of different numbers of power-generating wind turbines,
the storm track prediction computer receiving from the climate modeling computer a plurality of predicted storm patterns based on the plurality of combinations of wind turbine curtailment scenarios and selecting a wind turbine curtailment scenario which produces a most favorable storm track, and
communicating, from an output network coupled to the storm track prediction computer receiving the curtailment scenario producing the most favorable storm track, that curtailment scenario to a network of wind turbines, to curtail the wind turbines in such a manner as to optimally alter the storm track.

13. The method of claim 12, wherein the storm track computer calculates storm damage based on the plurality of predicted storm patterns, and selects the curtailment scenario producing the least amount of storm damage.

14. The method of claim 13, wherein storm damage is calculated based on predicted localized damage estimate calculations, including one or more of wind, flood, coastal inundation, storm tides, and location of populated areas relative to storm track.

15. The method of claim 12, wherein the storm track computer recalculates potential storm tracks over time, and adjusts wind turbine curtailment scenarios in response to recalculated potential storm tracks.

16. The method of claim 12, wherein the wind turbine curtailment scenarios comprise of one or more of feathering of individual or groups of power-generating wind turbines.

17. The method of claim 12, wherein the output network comprises a data network coupling the storm track prediction computer to a plurality of power-generating wind turbine operators.

18. A method for altering weather, comprising the steps of:
acquiring, with a plurality of weather data sensors, weather data in real-time,
modeling weather patterns in a climate modeling computer coupled to the plurality of weather data sensors and receiving the weather data in real-time,
receiving, in weather pattern prediction computer coupled to the climate modeling computer, the weather patterns from the climate modeling computer and calculating potential weather patterns,
iteratively adding a plurality turbine curtailment scenarios to the climate modeling computer, the plurality of turbine curtailment scenarios describing curtailing operations of different numbers of power-generating wind turbines,
the weather pattern prediction computer receiving from the climate modeling computer a plurality of predicted weather patterns based on the plurality of combinations of wind turbine curtailment scenarios and selecting a wind turbine curtailment scenario which produces a most favorable weather pattern, and
communicating, from an output network coupled to the weather pattern prediction computer receiving the curtailment scenario producing the most favorable weather pattern, that curtailment scenario to a network of wind turbines, to curtail the wind turbines in such a manner as to optimally alter the weather.

19. The method of claim 18, wherein the weather prediction computer recalculates potential weather patterns over time, and adjusts wind turbine curtailment scenarios in response to recalculated potential weather patterns.

20. The method of claim 18, wherein the wind turbine curtailment scenarios comprise of one or more of feathering of individual or groups of power-generating wind turbines.

21. The method of claim 18, wherein the output network comprises a data network coupling the weather pattern prediction computer to a plurality of power-generating wind turbine operators.
